(19) United States
(12) Patent Application Publication
(10) Pub. No.: US 2006/0020468 A1
(43) Pub. Date: Jan. 26, 2006

(54) Telephone mapping and traveler information dissemination system

(75) Inventor: Steven R. Hilliard, Knoxville, TN (US)

Correspondence Address: PITTS AND BRITTIAN P C, P O BOX 51295, KNOXVILLE, TN, 37950-1295, US

(73) Assignee: Inductive Signature Technologies, Inc., Knoxville, TN (US)

(21) Appl. No.: 10/897,608

(22) Filed: Jul. 23, 2004

(51) Int. Cl. G10L 21/00

(52) U.S. Cl. 704/270

(57) ABSTRACT

Methods and apparatus for a telephone based traveler information dissemination system that traffic and roadway condition information upon demand. A traveler communicates with a server over a telephone. The server receives a first and second geographic location and generates travel data, which is delivered to the traveler via facsimile or e-mail.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a telephone based traveler information dissemination system. More particularly, this invention pertains to a method and system for providing maps and traveler information through requests placed over a telephone.

2. Description of the Related Art

In 2000 the Federal Communications Commission designated “511” as the national traveler information phone number. It is expected that providers supporting the 511 number will provide weather related information, congestion information, traffic accident and incident information, and construction delay information.

U.S. Patent Application No. 2003/0171870, titled “Personalized traveler information dissemination system,” by Gueziec published on Sep. 11, 2003, discloses a computer-based system providing real-time information to a traveler. The system automatically collects, corrects, merges, and publishes information about traffic, transit, weather, public events, and other information useful to travelers. Once available, the information is published with very short system delays. The system provides for the elimination of outdated information on an ongoing basis. Gueziec discloses a Traveler Data Publisher 170 that is accessible over the Internet and a Traveler Data Dispatcher 180 that dispatches, or pushes, new information to subscriber devices, such as, cell phones, pagers, or email 195.

U.S. Pat. No. 6,675,147, titled “Input method for a driver information system,” issued to Woestemeyer, et al., on Jan. 6, 2004, discloses a driver information system 60 that accepts both speech input and keypad input. The driver information system 60 is a vehicle mounted system that includes a navigation system 69, a telephone 68, and a radio receiver 70. The Woestemeyer patent discloses a method for inputting information for control of the navigation system, telephone, and/or radio by either voice or keypad or any combination of voice or keypad.

### BRIEF SUMMARY OF THE INVENTION

According to one embodiment of the present invention, a telephone based traveler information dissemination system is provided. The system disseminates travel information, which, in various embodiments, includes one or more of a map of a geographic area, a map with routing information, a list of driving instructions, weather information, traffic conditions, and traffic forecasts. A system receives telephone calls from travelers who input a first and second geographic location that is used for generating the travel information. In one embodiment, the system includes a server that communicates with at least one telephone.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a histogram of traffic speed data for a 24 hour period;

FIG. 2 is a histogram of traffic volume data for a 24 hour period;

FIG. 3 is a histogram of traffic occupancy data for a 24 hour period;

FIG. 4 is a flow diagram of one embodiment of collecting and displaying traffic data;

FIG. 5 is a flow diagram of one embodiment of providing requested information; and

FIG. 6 is a block diagram of one embodiment of a network for storing and presenting data.

### DETAILED DESCRIPTION OF THE INVENTION

Methods and apparatus for a telephone based traveler information dissemination system that presents traffic and roadway condition information upon demand is disclosed. Traffic data is collected for many roadways. The traffic data includes, in various embodiments, speed data, volume data, occupancy data, and travel time data. Travelers desire to obtain this information, along with route maps and directions.

FIG. 1 illustrates a histogram of traffic speed data for a 24 hour period. The abscissa, or X-axis, 102 shows time for a 24 hour period, divided into one-hour increments. The ordinate, or Y-axis, 104 shows speed, which in the illustrated chart is measured in miles per hour. The data 112, 114 is representative of one-hour averages for a single lane of roadway. In one embodiment, this data is collected by monitoring vehicle speed road sensors installed in individual lanes of road. Speed is the velocity of a vehicle as it passes a vehicle speed road sensor.

The data 112 collected for the hour between 7 am and 8 am shows that the average speed over the sensor for that lane has fallen to 45 miles per hour (mph). Two hours later, between 10 am and 11 am, the data 114 shows that the average speed has increased to 66 mph. One explanation for the variation in speed is that morning rush-hour traffic has caused the average speed of the vehicles to drop, and the speed picks up after the rush-hour is over.

In various embodiments, the data is averaged over various times. In still another embodiment, the data is not averaged, but is collected as the instantaneous speed value for a specific time. If the speeds for every lane of a multiple lane roadway are averaged, an average speed for one direction of a roadway is determined. This information is valuable to motorists because a motorist may decide to use an alternate route if the average speed is less than is desired.

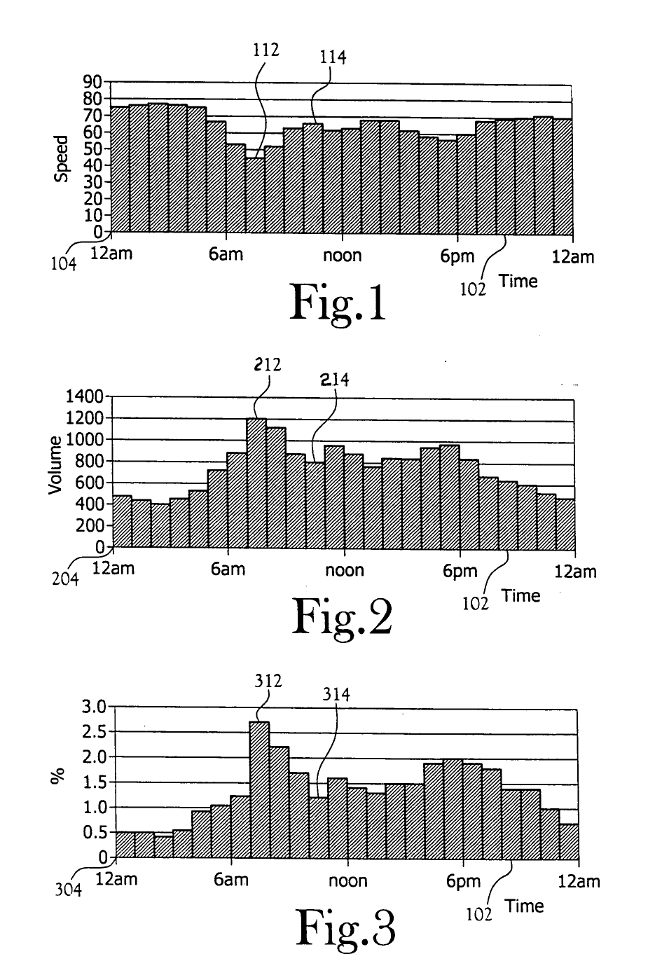

FIG. 2 illustrates a histogram of traffic volume data for a 24 hour period. The abscissa, or X-axis, 102 is time for a 24 hour period, divided into one-hour increments. The ordinate, or Y-axis, 204 is volume, which in the illustrated chart is measured in vehicles per hour passing a specific point. The data 212, 214 is representative of one-hour averages of the number of vehicles driving on a single lane of roadway. In one embodiment, this data is collected by monitoring vehicle road sensors installed in individual lanes of road. Volume is the number of vehicles passing a specific point in the roadway over a specified time.

The data 212 collected for the hour between 7 am and 8 am shows that the average number of vehicles passing over the sensor for that lane has increased to 1200 vehicles per hour. Two hours later, between 10 am and 11 am, the data 214 shows that the average number of vehicles has fallen to 800 vehicles per hour. One explanation for the variation in volume is that the number of vehicles has increased because of a morning rush hour. The volume drops after the rush hour is over.

In various other embodiments, the data is averaged over various times. If the volume measurements for every lane of a multiple lane roadway are averaged, an average volume for one direction of a roadway is determined. This information is valuable to motorists because a motorist may decide to use an alternate route if the roadway is congested, as shown by a high volume.

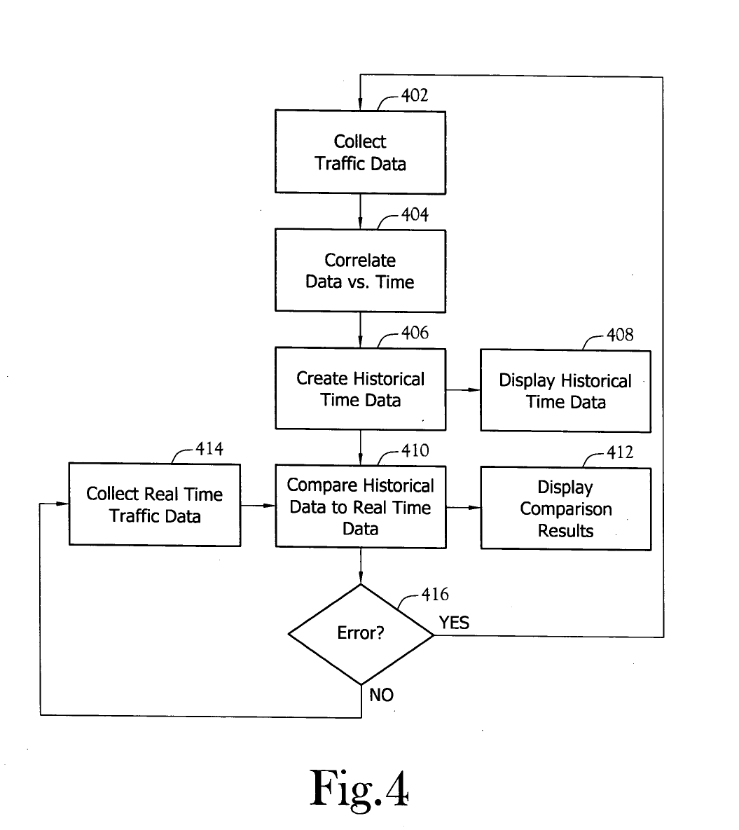

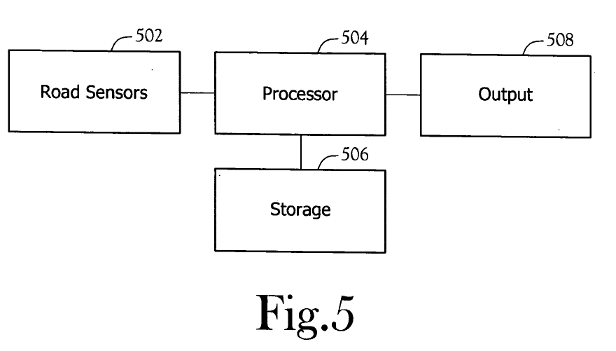

FIG. 3 illustrates a histogram of traffic occupancy data for a 24 hour period. The abscissa, or X-axis, 102 is time for a 24 hour period, divided into one-hour increments. The ordinate, or Y-axis, 304 is percent of occupancy, which in the illustrated chart is shown as a percentage. The data 312, 314 is representative of one-hour averages of the occupancy level on a single lane of roadway. In one embodiment, this data is collected by monitoring vehicle road sensors installed in individual lanes of road. Occupancy is the percentage of a specified section of roadway that is occupied by vehicles. For example, if a one-mile (5280 feet) section of road has an occupancy of 10 percent, then that section of roadway contains a number of vehicles that, if placed end-to-end, stretches 528 feet in length. Occupancy is determined by the percent of on-time of a vehicle presence detector.

The data 312 collected for the hour between 7 am and 8 am shows an occupancy of 2.7 percent. Two hours later, between 10 am and 11 am, the data 314 shows that the average occupancy has fallen to 1.2 percent. One explanation for the variation in occupancy is that the number of vehicles has increased because of a morning rush hour. The occupancy drops after the rush hour is over.

In various other embodiments, the data is averaged over various times. If the occupancy measurements for every lane of a multiple lane roadway are averaged, an average occupancy for one direction of a roadway is determined. This information is valuable to motorists because a motorist may decide to use an alternate route if the roadway is congested, as shown by a high occupancy.

Traffic patterns, such as those identified above in FIGS. 1 to 3, are classed as either regular or irregular conditions. Regular traffic conditions are those conditions that occur with a regular pattern, such as caused by a morning rush hour that occurs from Monday through Friday. Irregular traffic conditions are those conditions that do not occur with any predictable regularity. An example of an irregular traffic condition is an accident that causes traffic to slow or even come to a complete stop for a period. Although accidents are known to occur at a specified rate on certain roadways, the future time of an accident cannot be predicted.

As used herein, a section of roadway varies from a single point to a stretch of roadway. For example, in one embodiment, the road sensors 502 measuring speed, volume, and occupancy are point measures and return information relating to a specific point of roadway. In another embodiment, travel time is the average time a vehicle takes to travel from one point to another. Accordingly, travel time refers to a section of roadway that is defined by a length. Also, road and roadway are used interchangeably.

FIG. 4 illustrates a flow diagram of one embodiment of collecting and displaying traffic data. The first step is to collect traffic data 402. In various embodiments, the traffic data includes one or more of speed, volume, and occupancy data. The second step is to correlate the collected data versus time 404. The correlation step 404 results in data as illustrated in FIGS. 1 to 3. The next step is to create a set of historical time data 406. In one embodiment, the step of creating historical data sets 406 includes determining the regular traffic pattern for a period. In one embodiment, the set of historical time data is displayed 408.

Real time traffic data is collected 414 and, after the creation of historical data sets 406, a step of comparing the historical data to the real time data 410 is performed. In one embodiment, the comparison results are displayed 412.

The comparison of historical to real time data 410 produces an error value. If the error value exceeds a preset level 416, the latest real time data is collected 402 and the process repeats to create new historical time data 406. If the error is low or within acceptable limits, then additional real time data is collected 414. In the illustrated embodiment, the historical time data is verified with real time data to ensure that changes in traffic patterns are reflected in the historical time data.

FIG. 5 illustrates a flow diagram of one embodiment of acquiring and storing traffic data. Road sensors 502 are positioned upon selected portions of roadways and provide an input signal to a processor 504. The processor 504 performs data acquisition and stores the sensor data in a storage device 506. The processor 504 also processes the sensor data to create the historical time data for the monitored section of road, and this information is also stored in the storage unit 506. The processor 504 provides an output 508.

As used herein, the processor 504 should be broadly construed to mean any computer or component thereof that executes software. The processor 504 includes a memory medium that stores software, a processing unit that executes the software, and input/output (I/O) units for communicating with external devices. Those skilled in the art will recognize that the memory medium associated with the processor 504 can be either internal or external to the processing unit of the processor without departing from the scope and spirit of the present invention.

In one embodiment the processor 504 is a general purpose computer, in another embodiment, it is a specialized device for implementing the functions of the invention. Those skilled in the art will recognize that the processor 504 includes an input component, an output component, a storage component, and a processing component. The input component receives input from external devices, such as the road sensors 502. The output component sends output to external devices, such as the output device 508, which can be a video display unit or a printer. The storage component stores data and program code. In one embodiment, the storage component includes random access memory. In another embodiment, the storage component includes non-volatile memory, such as floppy disks, hard disks, and writeable optical disks. The processing component executes the instructions included in the software and routines.

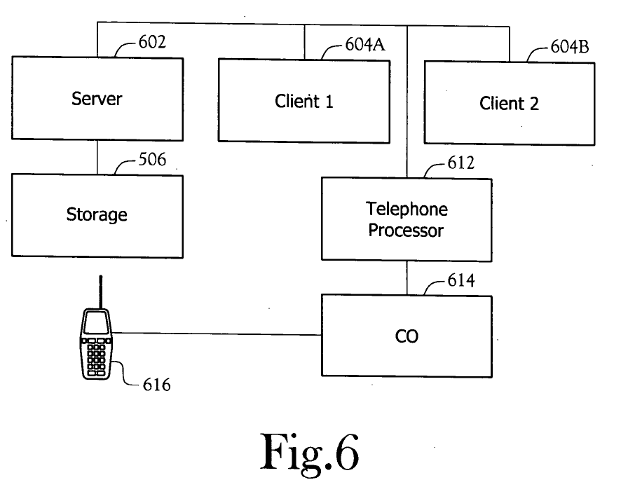

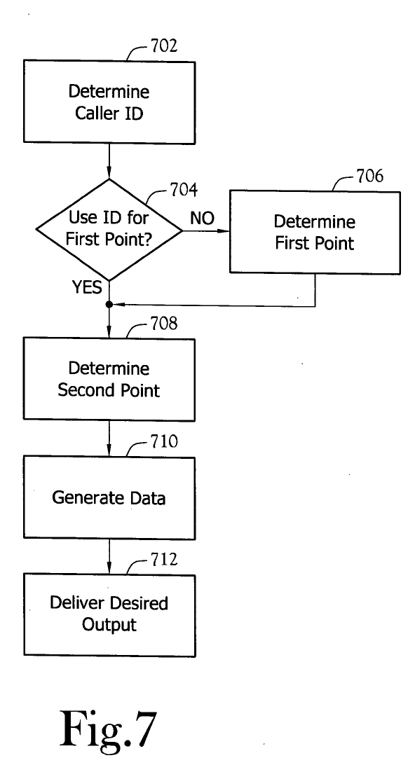

FIG. 6 illustrates a flow diagram of one embodiment of a simplified network for storing and presenting data. A server 602 with access to the data storage device 506 communicates with clients 604A, 604B connected to the network. In one embodiment, the server 602 and clients 604 communicate over the Internet.

The data storage device 506 is any of various devices known in the art for storing data, such as, but not limited to, a hard disk, a network attached storage device (NAS), recordable optical disks, and a stand-alone networked data storage device. Although FIG. 7 illustrates the data storage device 506 communicating directly with the server 602, in another embodiment, the data storage device 506 is connected to the network directly and communicates with the server 602 via the network.

Also connected to the network is a telephone processor 612, which is connected to a central office 614. The telephone processor 612 receives telephone calls and acts as an interface to the server 602. That is, the telephone processor 612, in various embodiments, retrieves the caller-ID of communicating telephones 616, accepts input from the communicating telephone 616, either verbal or by telephone keypad presses, and outputs voice data to the telephone 616. In one embodiment, the telephone processor 612 is a telephone router capable of handling multiple telephone calls at once. The central office 614 is a telephone facility that manages and routes calls from a telephone 616 to another telephone or other equipment 614.

As used herein, a “client” should be broadly construed to mean any computer or component thereof directly or indirectly connected or connectable in any known or later-developed manner to a computer network, such as the Internet or a local area network. Examples of a client include, but are not limited to, a personal computer, a terminal that communicates over the Internet, an Internet connected television, and a web-enabled cell-phone, PDA, or DSRC device. The client 604 runs, or executes, software that communicates with the server 602. The term “server” should also be broadly construed to mean a computer, computer platform, an adjunct to a computer or platform, or any component thereof that provides data or information to a client 604. The server 602 runs, or executes, software that allows it to properly handle and process client requests in addition to other processes necessary for the server 602 to perform its required functions. Of course, a client 604 should be broadly construed to mean the equipment that requests or gets a file or information, and a server 602 is the equipment that provides the file or information. These terms are based on the function of the associated equipment and the terms may interchange as the function of a particular piece of equipment changes.

For an HTML (hypertext markup language) based system, the client 604 runs or executes software that communicates with the server 602. The client software is typically known as browser software, and in one embodiment, is a standard web browser such as Netscape or Microsoft Internet Explorer. In other embodiments, custom software performs the functions of the browser software. The browser software executes on the client 604 and performs the functions of communicating with the server 602, displaying data and information provided by the server 602, sending user input from the client 604 to the server 602, and processing applets or sub-routines. Browser applets or sub-routines are programs executed on the client 604 that are controlled by the browser software to perform special functions not normally available in the browser software.

In one embodiment, each of the identified functions are performed by one or more software routines executed by the processor 508 and/or the server 602. In another embodiment, one or more of the functions identified are performed by hardware and the remainder of the functions are performed by one or more software routines run by the processor 608 and/or the server 602.

The processor 508 and the server 602 execute software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

FIG. 7 illustrates a flow diagram of one embodiment of providing requested information, such as when a traveler uses a telephone to call and request specific travel information. The first step after a traveler calls the system is for the server 602 or telephone processor 612 to determine the caller identification 702 so as to identify a first geographic location. In one embodiment, the first geographic location is identified automatically by the caller-ID of the traveler's telephone. In another embodiment, the first geographic location is determined from the global positioning system (GPS) coordinates provided by a GPS enabled telephone or device.

In other embodiments, the traveler inputs one of a published or pre-registered telephone or other number, a pre-registered identifier, a street address, a route designator, a ZIP code, or an option code from a list of verbally annunciated parameters. In these embodiments, the traveler performs the data input by either pressing keys on the telephone or by speaking the input values into the telephone.

If the traveler inputs a telephone number or is identified in the first step 702 by the caller-ID, the next step 704 is to determine whether the published location of the telephone number is to be used as the first geographic location. If the traveler does not desire that the published location be used 704, then the traveler inputs the first geographic location 706. In various embodiments, the traveler inputs one of a published or pre-registered telephone or other number, a street address, a route designator, a ZIP code, or an option code from a list of verbally annunciated parameters. In these embodiments, the traveler performs the data input by either pressing keys on the telephone or by speaking the input values into the telephone. In one embodiment, telephone numbers are converted to physical addresses by a reverse directory lookup. In other embodiments, physical addresses are converted to global coordinates, e.g. latitude and longitude, by comparing the addresses to a map database.

After the first geographic location is determined 704, 706, the second geographic location is determined 708. The second geographic location is determined in a manner similar to that of the step for determining the first geographic location 706. That is, in various embodiments, the traveler inputs, either verbally or manually, one of a published or pre-registered telephone or other number, a street address, a route designator, a ZIP code, or an option code from a list of verbally annunciated parameters. In another embodiment, the second geographic location is specified by the traveler inputting a radius or a distance, such as a number of miles or kilometers. In still another embodiment, the radius or distance is input in addition to other second geographic location information, which allows for the generation of a map showing an area surrounding the selected route.

After the first and second geographic locations are determined 704, 706, 708, the next step is for the server 602 or telephone processor 612 to generate the data 710 for delivery to the traveler 512. In one embodiment, the generated data 710 is a route between the first and second geographic locations. In various embodiments, the route is delivered as a map with the route highlighted, a list of turn-by-turn directions, or both. In other embodiments, the generated data is a map extending from the first geographical location a specified radius or distance or is a map showing a route and extending specified radius or distance from the route. In other embodiments, the generated data also includes weather conditions, traffic conditions, travel time, and/or traffic forecasts. In one embodiment, when traffic forecasts are requested, the traveler inputs a time and day of travel.

The generated data 710 is then delivered 712 by the server 602 or telephone processor 612. In one embodiment, the traveler inputs a facsimile number and the data is sent to that number via facsimile. In another embodiment, the traveler inputs an e-mail address and the data is e-mailed to that address. In one embodiment, the traveler is uniquely identified by his telephone number or other identification and the server 602 or telephone processor 612 uses a previously stored facsimile number or e-mail address. In still another embodiment, the server 602 or telephone processor 612 identifies the traveler as calling from a facsimile machine 616 and the output is delivered 712 to that facsimile machine 616 after the traveler terminates the telephone call. This embodiment allows a traveler to obtain the generated data 710 from a hotel or other remote location when Internet access is unavailable to the traveler.

The telephone based traveler information dissemination system includes various functions. The function of determining a first geographic location 702, 704, 706 is implemented, in various embodiments, by the server 602 or telephone processor 612 accepting a call from a telephone 616 and interpreting the information provided by the user. In one embodiment, the first geographic location is determined from a caller-ID of the telephone 601. In another embodiment, the first geographic location is determined from a GPS provided location from a GPS enabled telephone or device. In other embodiments, the first geographic location is determined from one of a published telephone number, a pre-registered telephone number, a pre-registered identifier, a street address, a route designator, a ZIP code, and an option code from a list of verbally annunciated parameters. In these embodiments, the user has previously established or registered numbers or identifiers that identifies the user's account in which various data is stored, for example, predefined routes, starting locations, and destinations. In one embodiment in which the system provides a list of verbally annunciated parameters, the server 602 or telephone processor 612 determines a likely location of the user based upon the user's identity and provides an audio playback of likely locations, for example, the user's home, work, one or more user-defined routes or locations, or major landmarks near the address associated with the user's telephone number or identity. In various embodiments, this function includes accepting user input either verbally or by telephone keypad presses.

The function of determining a second geographic location 708 is implemented, in one embodiment, by the server 602 or telephone processor 612 interpreting the information provided by the user. In various embodiments, the second geographic location is determined from one of a published telephone number, a pre-registered telephone number, a pre-registered identifier, a street address, a route designator, a ZIP code, an option code from a list of verbally annunciated parameters, and a distance from said first geographic location. In these embodiments, the user has previously established or registered numbers or identifiers that identifies the user's account in which various data is stored, for example, predefined routes, starting locations, and destinations. In one embodiment in which the system provides a list of verbally annunciated parameters, the server 602 or telephone processor 612 determines a likely location of the user based upon the user's identity and provides an audio playback of likely locations, for example, the user's home, work, one or more user-defined routes or locations, or major landmarks near the address associated with the user's telephone number or identity. In various embodiments, this function includes accepting user input either verbally or by telephone keypad presses.

The function of generating a set of travel data 710 is implemented, in one embodiment, by the server 602 or telephone processor 612 generating set of travel data 710 including at least one of a map of a geographic area defined by the first and second geographic locations, a map with routing information between the first and second geographic locations, a list of driving instructions from the first geographic location to the second geographic location, a description of weather conditions associated with the first and second geographic locations, a description of traffic conditions between the first and second geographic locations, a travel time forecast from the first geographic location to the second geographic location, and a traffic forecast between the first and second geographic locations.

The function of transmitting a set of travel data 712 is implemented, in various embodiments, by the server 602 or telephone processor 612 communicating with a facsimile machine or an e-mail client to deliver the travel data to a facsimile number or e-mail address.

The function of determining a delivery destination for the set of travel data is implemented, in one embodiment, by the server 602 or telephone processor 612 interpreting the information provided by the user. In one embodiment, the user originates the call from a facsimile machine 616 and the server 602 or telephone processor 612 uses that facsimile machine 616 as the delivery destination. In various other embodiments, the destination for the set of travel data is determined from one of a published telephone number, a pre-registered telephone number, a pre-registered identifier, a street address, a route designator, a ZIP code, and an option code from a list of verbally annunciated parameters. In these embodiments, the user has previously established or registered numbers or identifiers that identifies the user's account in which various data is stored, for example, predefined delivery numbers such as a facsimile number and/or an e-mail address. In one embodiment in which the system provides a list of verbally annunciated parameters, the server 602 or telephone processor 612 provides an audio playback of likely delivery locations, such as those pre-defined by the user. In various embodiments, this function includes accepting user input either verbally or by telephone keypad presses.

From the foregoing description, it will be recognized by those skilled in the art that a telephone based traveler information dissemination system has been provided. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. An apparatus for disseminating travel information, said apparatus comprising:
a computer having a processing unit, a storage unit, and an input/output unit, said computer programmed to execute a process comprising the steps of:
receiving a first geographic location communicated from a telephone,
receiving a second geographic location communicated from said telephone,
generating a set of travel data, said set of travel data including at least one of a map of a geographic area defined by said first and second geographic locations, a map with routing information between said first and second geographic locations, a list of driving instructions from said first geographic location to said second geographic location, a description of weather conditions associated with said first and second geographic locations, a description of traffic conditions between said first and second geographic locations, a travel time forecast from said first geographic location to said second geographic location, and a traffic forecast between said first and second geographic locations,
determining one of a facsimile number and an e-mail address, and
transmitting said set of travel data to one of said facsimile number and said e-mail address.

2. The apparatus of claim 1 wherein said process further includes a step of determining an identity of a person using said telephone.

3. The apparatus of claim 1 wherein said first geographic location is determined from one of a caller-ID of said telephone and a global positioning system provided location.

4. The apparatus of claim 1 wherein said first geographic location is determined from one of a published telephone number, a pre-registered telephone number, a pre-registered identifier, a street address, a route designator, a ZIP code, and an option code from a list of verbally annunciated parameters.

5. The apparatus of claim 1 wherein said second geographic location is determined from one of a published telephone number, a pre-registered telephone number, a pre-registered identifier, a street address, a route designator, a ZIP code, an option code from a list of verbally annunciated parameters, and a distance from said first geographic location.

6. The apparatus of claim 1 wherein each of said first geographic location and said second geographic location is determined from one of an input spoken into said telephone and an input from a telephone keypad.

7. The apparatus of claim 1 wherein said step of determining one of said facsimile number and said e-mail address includes determining said telephone is a facsimile machine and using a telephone number of said telephone as said facsimile number.

8. The apparatus of claim 1 wherein said step of determining one of said facsimile number and said e-mail address includes retrieving one of said facsimile number and said e-mail address previously stored and associated with an identity of a person using said telephone.

9. At least one computer programmed to execute a process for disseminating travel information, said process comprising the steps of:
receiving a first geographic location communicated from a telephone;
receiving a second geographic location communicated from said telephone;
generating a set of travel data;
determining one of a facsimile number and an e-mail address; and
transmitting said set of travel data to one of said facsimile number and said e-mail address.

10. The process of claim 9 wherein said set of travel data includes at least one of a map of a geographic area defined by said first and second geographic locations, a map with routing information between said first and second geographic locations, a list of driving instructions from said first geographic location to said second geographic location, a description of weather conditions associated with said first and second geographic locations, a description of traffic conditions between said first and second geographic locations, a travel time forecast from said first geographic location to said second geographic location, and a traffic forecast between said first and second geographic locations.

11. The process of claim 9 wherein said first geographic location is determined from one of a caller-ID of said telephone and a global positioning system provided location.

12. The process of claim 9 wherein said step of receiving said first geographic location includes determining said first geographic location from one of a published telephone number, a pre-registered telephone number, a pre-registered identifier, a street address, a route designator, a ZIP code, and an option code from a list of verbally annunciated parameters.

13. The process of claim 9 wherein said step of receiving said first geographic location includes retrieving said first geographic location previously stored and associated with an identity of a person using said telephone.

14. The process of claim 9 wherein said step of receiving said second geographic location includes determining said second geographic location from one of a published telephone number, a pre-registered telephone number, a pre-registered identifier, a street address, a route designator, a ZIP code, an option code from a list of verbally annunciated parameters, and a distance from said first geographic location.

15. The process of claim 9 wherein said step of receiving said second geographic location includes retrieving said second geographic location previously stored and associated with an identity of a person using said telephone.

16. The process of claim 9 wherein each of said steps of receiving said first geographic location and receiving said second geographic location includes receiving one of an input spoken into said telephone and an input from a telephone keypad.

17. A system for disseminating travel information, said system comprising:
a storage component storing a plurality of sets of traffic data;
an input/output component for communicating with a telephone router; and
a processing component executing a process including
receiving a first geographic location communicated from a telephone;
receiving a second geographic location communicated from said telephone;
generating a set of travel data;
determining one of a facsimile number and an e-mail address; and
transmitting said set of travel data to one of said facsimile number and said e-mail address.

18. The system of claim 17 wherein said process further includes a step of determining an identify of a person using said telephone.

19. The system of claim 17 wherein said first geographic location is determined from one of a caller-ID of said telephone and a global positioning system provided location.

20. The system of claim 17 wherein said first geographic location is determined from one of a published telephone number, a pre-registered telephone number, a pre-registered identifier, a street address, a route designator, a ZIP code, and an option code from a list of verbally annunciated parameters.

21. The system of claim 17 wherein said second geographic location is determined from one of a published telephone number, a pre-registered telephone number, a pre-registered identifier, a street address, a route designator, a ZIP code, an option code from a list of verbally annunciated parameters, and a distance from said first geographic location.

22. The system of claim 17 wherein each of said first geographic location and said second geographic location is determined from one of an input spoken into said telephone and an input from a telephone keypad.

23. The system of claim 17 wherein said storage unit contains a set of traffic data.

24. The system of claim 17 wherein said step of determining one of said facsimile number and said e-mail address includes retrieving one of said facsimile number and said e-mail address previously stored and associated with an identity of a person using said telephone.

25. An apparatus for disseminating travel information, said apparatus comprising:
a means for determining a first geographic location;
a means for determining a second geographic location;
a means for generating a set of travel data; and
a means for transmitting said set of travel data.

26. The apparatus of claim 25 further including a means for determining a delivery destination for said set of travel data.

27. A method in a computer system for disseminating travel information, said method comprising the steps of:
providing for receiving a first geographic location communicated from a telephone;
providing for receiving a second geographic location communicated from said telephone;
providing for generating a set of travel data, said set of travel data including at least one of a map of a geographic area defined by said first and second geographic locations, a map with routing information between said first and second geographic locations, a list of driving instructions from said first geographic location to said second geographic location, a description of weather conditions associated with said first and second geographic locations, a description of traffic conditions between said first and second geographic locations, a travel time forecast from said first geographic location to said second geographic location, and a traffic forecast between said first and second geographic locations; and
providing for transmitting said set of travel data to one of a facsimile number and an e-mail address.

28. The method of claim 27 further including a step of providing for determining one of said facsimile number and said e-mail address.

29. The method of claim 27 further including a step of providing for determining one of said facsimile number and said e-mail address, which includes retrieving one of said facsimile number and said e-mail address previously stored and associated with an identity of a person using said telephone.

30. The method of claim 27 further including a step of providing for determining an identify of a person using said telephone.

31. The method of claim 27 wherein said first geographic location is determined from one of a caller-ID of said telephone and a global positioning system provided location.

32. The method of claim 27 wherein said step of providing for receiving said first geographic location includes providing for determining said first geographic location from one of a published telephone number, a pre-registered telephone number, a pre-registered identifier, a street address, a route designator, a ZIP code, and an option code from a list of verbally annunciated parameters.

33. The method of claim 27 wherein said step of providing for receiving said first geographic location includes providing for retrieving said first geographic location previously stored and associated with an identity of a person using said telephone.

34. The method of claim 27 wherein said step of providing for receiving said second geographic location includes providing for determining said second geographic location from one of a published telephone number, a pre-registered telephone number, a pre-registered identifier, a street address, a route designator, a ZIP code, an option code from a list of verbally annunciated parameters, and a distance from said first geographic location.

35. The method of claim 27 wherein said step of providing for receiving said second geographic location includes providing for retrieving said second geographic location previously stored and associated with an identity of a person using said telephone.

36. The method of claim 27 wherein each of said steps of providing for receiving said first geographic location and providing for receiving said second geographic location includes providing for receiving one of an input spoken into said telephone and an input from a telephone keypad.

37. A method in a computer system for disseminating travel information, said method comprising the steps of:
providing for receiving a first geographic location communicated from a telephone;
providing for receiving a second geographic location communicated from said telephone;
providing for generating a set of travel data;
providing for determining one of a facsimile number and an e-mail address; and
providing for transmitting said set of travel data to one of said facsimile number and said e-mail address.

38. The method of claim 37 wherein said set of travel data includes at least one of a map of a geographic area defined by said first and second geographic locations, a map with routing information between said first and second geographic locations, a list of driving instructions from said first geographic location to said second geographic location, a description of weather conditions associated with said first and second geographic locations, a description of traffic conditions between said first and second geographic locations, a travel time forecast from said first geographic location to said second geographic location, and a traffic forecast between said first and second geographic locations.

39. The method of claim 37 further including a step of providing for determining one of said facsimile number and said e-mail address, which includes retrieving one of said facsimile number and said e-mail address previously stored and associated with an identity of a person using said telephone.

40. The method of claim 37 further including a step of providing for determining an identity of a person using said telephone.

41. The method of claim 37 wherein said first geographic location is determined from one of a caller-ID of said telephone and a global positioning system provided location.

42. The method of claim 37 wherein said step of providing for receiving said first geographic location includes providing for determining said first geographic location from one of a published telephone number, a pre-registered telephone number, a pre-registered identifier, a street address, a route designator, a ZIP code, and an option code from a list of verbally annunciated parameters.

43. The method of claim 37 wherein said step of providing for receiving said first geographic location includes providing for retrieving said first geographic location previously stored and associated with an identity of a person using said telephone.

44. The method of claim 37 wherein said step of providing for receiving said second geographic location includes providing for determining said second geographic location from one of a published telephone number, a pre-registered telephone number, a pre-registered identifier, a street address, a route designator, a ZIP code, an option code from a list of verbally annunciated parameters, and a distance from said first geographic location.

45. The method of claim 37 wherein said step of providing for receiving said second geographic location includes providing for retrieving said second geographic location previously stored and associated with an identity of a person using said telephone.

46. The method of claim 37 wherein each of said steps of providing for receiving said first geographic location and providing for receiving said second geographic location includes providing for receiving one of an input spoken into said telephone and an input from a telephone keypad.

47. Computer readable media tangibly embodying a program of instructions executable by a computer to perform a method for disseminating travel information, said method comprising:
receiving a first geographic location communicated from a telephone;
receiving a second geographic location communicated from said telephone;
generating a set of travel data;
determining one of a facsimile number and an e-mail address; and
transmitting said set of travel data to one of said facsimile number and said e-mail address.

48. The media of claim 47 wherein said set of travel data includes at least one of a map of a geographic area defined by said first and second geographic locations, a map with routing information between said first and second geographic locations, a list of driving instructions from said first geographic location to said second geographic location, a description of weather conditions associated with said first and second geographic locations, a description of traffic conditions between said first and second geographic locations, a travel time forecast from said first geographic location to said second geographic location, and a traffic forecast between said first and second geographic locations

49. The media of claim 47 wherein said first geographic location is determined from one of a caller-ID of said telephone and a global positioning system provided location.

50. The media of claim 47 wherein said step of receiving said first geographic location includes determining said first geographic location from one of a published telephone number, a pre-registered telephone number, a pre-registered identifier, a street address, a route designator, a ZIP code, and an option code from a list of verbally annunciated parameters.

51. The media of claim 47 wherein said step of receiving said first geographic location includes retrieving said first geographic location previously stored and associated with an identity of a person using said telephone.

52. The media of claim 47 wherein said step of receiving said second geographic location includes determining said second geographic location from one of a published telephone number, a pre-registered telephone number, a pre-registered identifier, a street address, a route designator, a ZIP code, an option code from a list of verbally annunciated parameters, and a distance from said first geographic location.

53. The media of claim 47 wherein said step of receiving said second geographic location includes retrieving said second geographic location previously stored and associated with an identity of a person using said telephone.

54. The media of claim 47 wherein each of said steps of receiving said first geographic location and receiving said second geographic location includes receiving one of an input spoken into said telephone and an input from a telephone keypad.

55. A method in a computer system for communicating travel information with a user, comprising:
presenting a prompt to the user for inputting a first geographic location communicated from a telephone;
presenting an indication to the user that said first geographic location was received;
presenting a prompt to the user for inputting a second geographic location communicated from said telephone;
presenting an indication to the user that said second geographic location was received;
presenting an indication to the user that a set of travel data is to be transmitted to one of a facsimile number and an e-mail address.

56. The method of claim 55 further including a step of presenting a prompt to the user for inputting one of said facsimile number and said e-mail address

57. The method of claim 27 wherein said step of presenting a prompt for inputting said first geographic location includes accepting one of a published telephone number, a pre-registered telephone number, a pre-registered identifier, a street address, a route designator, a ZIP code, and an option code from a list of verbally annunciated parameters.

58. The method of claim 27 wherein said step of presenting a prompt for inputting said first geographic location includes accepting a previously stored location associated with an identity of a person using said telephone.

59. The method of claim 27 wherein said step of presenting a prompt for inputting said second geographic location includes accepting one of a published telephone number, a pre-registered telephone number, a pre-registered identifier, a street address, a route designator, a ZIP code, an option code from a list of verbally annunciated parameters, and a distance from said first geographic location.

60. The method of claim 27 wherein said step of presenting a prompt for inputting said second geographic location includes providing accepting a previously stored location associated with an identity of a person using said telephone.

61. The method of claim 27 wherein each of said steps of presenting a prompt for inputting said first geographic location and presenting a prompt for inputting said second geographic location includes accepting one of an input spoken into said telephone and an input from a telephone keypad.
